(19) United States
(12) Patent Application Publication
(10) Pub. No.: US 2008/0253595 A1
(43) Pub. Date: Oct. 16, 2008

(54) Method for adjusting a binaural hearing device system

(75) Inventor: Andre Steinbuss, Erlanger (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 12/148,115

(22) Filed: Apr. 16, 2008

(30) Foreign Application Priority Data
Apr. 16, 2007 (DE) 10 2007 017 761.7

(51) Int. Cl. H04R 25/00

(52) U.S. Cl. 381/312

(57) ABSTRACT

A binaural hearing device system is to be adjusted individually better. A method is provided for adjusting a hearing device system having a first hearing device for supplying a first ear and a second hearing device for supplying the second ear of a hearing device wearer by configuring the first hearing device with reference to audiometric data about the first ear. Additionally, in order to configure the first hearing device audiometric data about the second ear and/or hardware information about the second hearing device are also used. Owing to the fact that the stereo hearing and both supplying hearing devices are regarded in this way as a unit, a more individualized adjustment can take place than would be the case with separate adjustment of the individual hearing devices.

### CROSS REFERENCE TO RELATED APPLICATIONS

This application claims priority of German application No. 10 2007 017 761.7 DE filed Apr. 16, 2007, which is incorporated by reference herein in its entirety.

### FIELD OF INVENTION

The present invention relates to a method for adjusting a hearing device system having a first hearing device for supplying the first ear and a second hearing device for supplying the second ear of a hearing device wearer by configuring the first hearing device with reference to audiometric data about the first ear.

### BACKGROUND OF INVENTION

Hearing devices are wearable hearing apparatuses which assist hard-of-hearing people. In order to accommodate numerous individual requirements, various types of hearing devices are available such as behind-the-ear (BTE) hearing devices and in-the-ear (ITE) hearing devices, for example also concha hearing devices or completely-in-the-canal (CIC) hearing devices. The hearing devices listed as examples are worn on the outer ear or in the auditory canal. Bone conduction hearing aids, implantable or vibrotactile hearing aids are also available on the market. The damaged ear is thus stimulated either mechanically or electrically.

The key components of hearing devices are principally an input converter, an amplifier and an output converter. The input converter is normally a sound receiver e.g. a microphone and/or an electromagnetic receiver, e.g. an induction loop. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording sound from the environment are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or earpiece 4, which outputs an acoustic signal. Sound is transmitted through a sound tube, which is fixed in the auditory canal by means of an otoplastic, to the device wearer's eardrum. Power for the hearing device and in particular for the signal processing unit 3 is supplied by means of a battery 5 which is also integrated in the hearing device housing 1.

Audiometric data and details about the personal profile of the hard-of-hearing person are the basis for the adjustment of the hearing device. Said details can include for example experience with hearing systems and information about the lifestyle (active/passive, young/old, working/retired, etc.) of the hard-of-hearing person. This information is side-independent for a binaural system and affects the pre-configuration of the hearing system in equal measure on both sides following the initial adjustment.

By contrast the audiometric data is only taken into consideration for the basic configuration of the frequency- and level-dependent amplification of the respective side of the binaural hearing system. However further parameters such as for example the threshold for a background noise suppression or the time constants for the various algorithms of a hearing system should be symmetrically set on both supplied sides in order to achieve a symmetrical auditory impression. This is critical among other things for the localizing ability. Such adjustments are currently performed simply through the profile of the hard-of-hearing person. However further parameters are not incorporated into the adjustment of the hearing device. Thus for example the amplifications of the two hearing devices of a hearing device system are always set individually. For a binaural adjustment of loudness the amplification may be reduced in both devices by e.g. 3 dB since the loudness impression in binaural supply is amplified compared to single supply.

An adjusting device for hearing devices is known from the publication WO 2005/086537 A1 for example. The adjusting device features a computer with a display for the visual representation of data, a data input for inputting hearing aid program data into the adjusting device, a data memory and a data output for outputting the data to a hearing aid. Means are furthermore provided for the selection of simultaneous configurations relating to two or several different parameters for sound processing in the hearing aid to be programmed.

A binaural hearing device supply for directional hearing is known from the patent specification DE 102 28 632 B3. Accordingly an amplification value of one of the hearing aids can be transferred to the other. The signal amplitudes are then compared, with the amplification being changed in at least one of the hearing aids. The comparison can take into consideration the audiograms measured at both ears. This makes it possible for example for a loudness change effected by a parameter change in one hearing aid to bring about a loudness change in the other hearing aid that is subjectively identical for the hearing aid wearer.

Patent specification DE 10 2004 051 325 B3 further discloses a method for adjusting the transmission characteristics of a hearing device. In particular an option is described for configuring a binaural supply system comprising two hearing aids. Since both ears of a user frequently have a similar hearing loss it is accordingly advantageous firstly to take over the settings selected on the hearing aid for the supply of an ear to the second hearing aid and then simply to perform fine-tuning on the hearing aid for the supply of the second ear. Patent specification U.S. Pat. No. 7,018,342 B2 relates to a method for determining masking levels in an automated hearing test. Here various hearing thresholds are determined for air conduction and bone conduction.

A compression circuit for hearing devices is further described in the publication DE 196 24 092 B4. Compression increases relatively sharply below the individual discomfort threshold so that the hearing is not damaged by loud sounds.

### SUMMARY OF INVENTION

The object of the present invention is thus to provide a method for adjusting a hearing device system having two hearing devices, with said method leading to a more individualized configuration of the binaural supply.

This object is inventively achieved by means of a method for adjusting a hearing device system having a first hearing device for supplying the first ear and a second hearing device for supplying the second ear of a hearing device wearer by configuring the first hearing device with reference to audiometric data about the first ear, with hardware information about the second hearing device also being used to configure the first hearing device.

Thus both hearing devices can be configured in a binaural hearing system as a function of the hardware of the other hearing device in each case.

The inventive method advantageously makes it possible for the hearing devices to be configured symmetrically on the basis of a binaural audiogram if audiometric data about the second ear is also drawn upon for configuration of the first hearing device.

The audiometric data preferably comprises an air conduction hearing threshold, a bone conduction hearing threshold and/or a discomfort threshold. With these thresholds for example the residual dynamic range for example at the left ear can be taken into consideration for the configuration of the hearing device at the right ear.

It is further advantageous if the regulation time for the compression in the first hearing device is adjusted to the residual dynamic range of the second ear. Thus for example a shorter attack time can be selected for the compression for the first hearing device if this requires the residual dynamic range not of the first ear but rather of the second ear. By selecting identical time constants on both sides a symmetrical auditory impression is achieved for the hard-of-hearing person.

In addition a peak clipping of the output signal of the first hearing device can take place as a function of the data about the second ear or about the second hearing device. Furthermore a configuration of a microphone mode (omnidirectional, directional, automatic) or of a volume and sound level of a signal of the first hearing device can also be performed as a function of this data. A threshold of a background noise suppression of the first hearing device can also be configured as a function of the data about the second ear or about the second hearing device. Generally processing algorithms in the first hearing device can thus be better adjusted to the individual hearing loss by taking account of the hearing loss at the second ear and/or by taking account of the data about the second hearing device.

The aforementioned hardware information can concern the device type, namely an ITE or BTE. Thus the coaction of the device pair can be better adjusted to the individual hearing loss.

Furthermore the hardware information can concern the amplifier type or the sound transmission within the second hearing device. The hardware information can particularly relate to an acoustic characteristic of an otoplastic of the second hearing device. Thus for example the acoustic influence of wearing hooks, sound tubes and the like as well as other device data of the other hearing device in each case can be taken into consideration in the adjustment.

### BRIEF DESCRIPTION OF THE DRAWINGS

The present invention is described in more detail with reference to the appended drawings, in which

FIG. 1 shows a basic configuration of a hearing device according to the prior art;

FIG. 2 shows a symbolic representation of the reciprocal use according to the invention of audiograms in the adjustment of hearing devices of a binaural hearing system;

FIG. 3 shows an audiogram of a first hearing device wearer for his right side;

FIG. 4 shows an audiogram of the first hearing device wearer for his left side;

FIG. 5 shows an audiogram of a second hearing device wearer for his right side; and

FIG. 6 shows an audiogram of the second hearing device wearer for his left side.

### DETAILED DESCRIPTION OF INVENTION

The preferred embodiments shown in more detail below represent exemplary embodiments of the present invention.

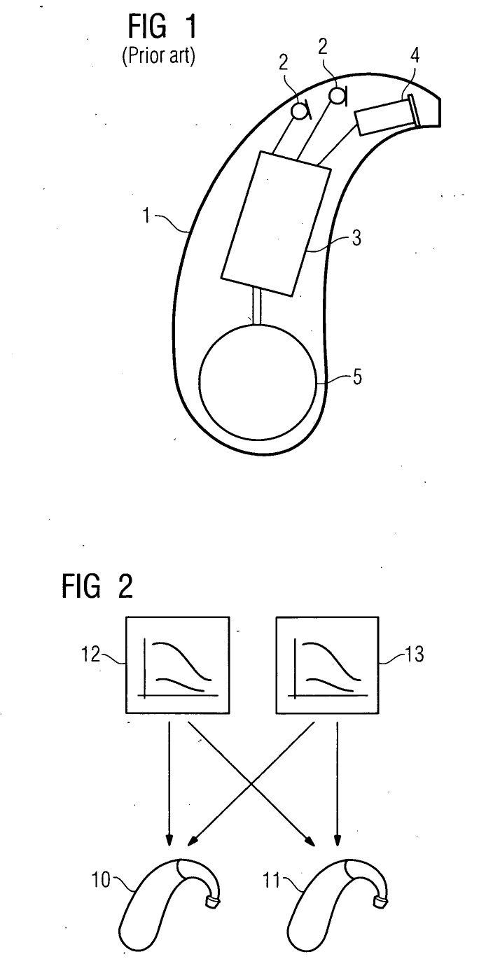

FIG. 2 symbolically shows an inventive adjustment method such as one that can be performed for example by an audiologist. Accordingly both hearing devices 10, 11 of a binaural hearing system are adjusted to the individual hearing loss of a hard-of-hearing person. The first hearing device 10 (“left hearing device” for short) supplies the left ear and the second hearing device 111 (“right hearing device”) here supplies the right ear. Prior to the adjustment a left audiogram 12 and a right audiogram 13 were calculated from the left side of the hard-of-hearing person. According to the invention not only the left audiogram 12 but also the right audiogram 13 is taken into consideration here for the adjustment of the left hearing device 10. In the same way the left audiogram 12 is also taken into consideration in addition to the right audiogram 13 for the adjustment of the right hearing device 11. Here both audiograms 12 and 13 symbolically represent any audiometric data as well as hardware data about the individual hearing devices. Thus for example hardware data such as hearing device type (ITE or BTE), amplifier type, wearing hook, sound tube, etc. of the right hearing device 11 can also be drawn upon for the adjustment of the left hearing device 10 or vice versa.

The problem of various configurations of a binaural hearing device system is thus solved by an adjustment device and/or adjustment software for a binaural hearing system requesting information from one side about the other side (hearing loss, device used, adjustment strategy, etc.) during adjustment of a device and using said information for pre-configuration of the binaural hearing system. Thus an otherwise typical bilateral monaural adjustment is supplemented insofar as with the aid of information about the binaural hearing loss and/or the binaural device combination the pre-configuration of the hearing devices is less generalized for the individual hearing loss and the actual hearing loss can thus be taken into account more decisively.

Additionally any criteria which would previously have been avoided owing to the risk of differing configurations on each side can be supplemented with the information about the hearing loss on the other side. A more reliable classification of the hearing loss can be achieved thereby. Furthermore the risk of differing configurations on each side is consequently reduced significantly. Frequency- and level-dependent amplification values which continue to be calculated individually for each side remain unaffected.

By taking account of binaural conditions in the adjustment, in particular in the initial adjustment, the embodiments of the basic configuration of a hearing system set out below are possible. However further possible embodiments are conceivable in addition to the examples listed here.

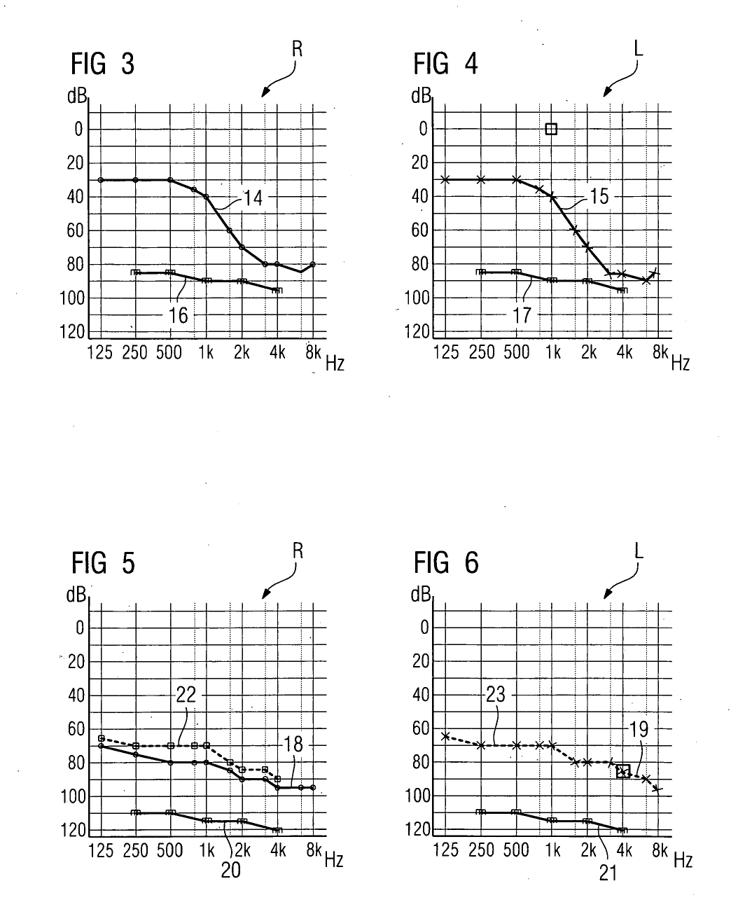

a) FIGS. 3 and 4 show a right audiogram and a left audiogram of a hard-of-hearing person. The hearing range across the frequency is limited in each case by an air conduction hearing threshold 14, 15 and a discomfort threshold 16, 17. It should be noted that the air conduction hearing thresholds 14, 15 in the left audiogram and in the right audiogram follow the same trend below 2 kHz. In the higher spectral range the hearing loss on the left is rather greater. Since the discomfort thresholds 16, 17 follow the same trend on the left and right sides the residual dynamic range at high frequencies is considerably lower on the left side than on the right side. In the example selected in FIG. 4 the residual dynamic range is below 10 dB. For such hearing losses with a significantly reduced residual dynamic range (audiometric difference between air conduction hearing threshold and discomfort threshold) the theory proposes shorter attack and decay times for the input compression (AGCi). It is only possible in this way to prevent a varying input level from leading to an output level that is outside the narrow residual dynamic range. Therefore in frequency ranges with a lower residual dynamic range, shorter attack and decay times are striven for the basic configuration. For this purpose a threshold value to be defined (e.g. residual dynamic range<15 dB) can be drawn upon. The attack and decay times greatly influence the sound of a hearing system. Since in the example of FIGS. 3 and 4 the residual dynamic range in the high frequency range is greater than 10 dB on the right side and lower than 10 dB on the left side the compression would be configured on the right side with a low control speed and on the left side with a high control speed at a threshold of 10 dB. The corresponding differing attack and decay times for the right and left side would cause a differing auditory impression on each side although the audiogram appears almost symmetrical. By querying the binaural hearing loss in this case symmetrical time constants for the input compression can be selected. The same applies in this example for a configuration of possible peak cutoffs (adaptive filters, output level limiting) for which hearing loss-dependent and residual dynamic range-dependent thresholds are also expedient. These algorithms can then also be configured symmetrically for both hearing systems.

b) Hard-of-hearing people with a high degree of hearing loss (compare right and left audiogram in FIGS. 5 and 6) generally benefit little from adaptive filters for background noise reduction. These configurations are sometimes even rejected because the device sounds “too dry”. It would also be expedient here to configure the effect of a background noise suppression as a function of the hearing loss. Nevertheless in accordance with current practice this is avoided since a criterion that is set in any way can lead to differing configurations on each side. In this example too however by additionally querying the binaural hearing loss the actual hearing loss can be classified more precisely and individual parameters such as the threshold for background noise suppression can be configured as a function of the hearing loss without running the risk of ending up with differing configurations on each side after the basic configuration. For the high actual hearing loss here FIGS. 5 and 6 show not only the air conduction hearing thresholds 18 and 19 as well as the discomfort thresholds 20 and 21 in each case for the right and left side but also the bone conduction hearing thresholds 22 and 23. While the bone conduction hearing threshold 22 on the right side is considerably higher than the air conduction hearing threshold 18, the bone conduction hearing threshold 23 on the left side lies directly on the air conduction hearing threshold 19. This type of differing hearing loss on both sides can be taken into consideration in the adjustment of both hearing devices by drawing upon both conduction hearing thresholds in each case for the adjustment of the device on the other side. This can also help to avoid differing configurations on each side.

c) The option of querying the hearing device on the other side allows for further options for the more individualized adjustment of hearing devices. Thus the example b) can be modified insofar as a query is raised as to whether a hearing system for profoundly hard-of-hearing people is used on both sides. In this case individual parameters such as the threshold for noise suppression can be configured as a function of the device pair actually in use. In this way for example the hearing device type and/or amplifier type of one hearing device can be drawn upon for the adjustment of the other hearing device.

1.-13. (canceled)

14. A method for adjusting a hearing device system having a first hearing device for supplying the first ear and a second hearing device for supplying the second ear of a hearing device wearer, comprising:
configuring the first hearing device with reference to audiometric data about the first ear; and
configuring the first hearing device using hardware information about the second hearing device.

15. The method as claimed in claim 14, wherein audiometric data about the second ear is based on the configuration of the first hearing device.

16. The method as claimed in claim 15 wherein the audiometric data comprises a bone conduction hearing threshold.

17. The method as claimed in claim 15 wherein the audiometric data comprises a discomfort threshold.

18. The method as claimed in claim 15 wherein a selected regulation time for the compression in the first hearing device is made shorter than a residual dynamic range of the second ear.

19. The method as claimed in claim 15 wherein a peak cutoff of an output signal of the first hearing device takes place as a function of the audiometric data about the second ear or of the hardware information about the second hearing device.

20. The method as claimed in claim 15 wherein volume and sound level of the signal sound of the first hearing device is configured as a function of the audiometric data about the second ear or of the hardware information about the second hearing device.

21. The method as claimed in claim 15 wherein a microphone mode of the first hearing device is configured as a function of the audiometric data about the second ear or of the hardware information about the second hearing device.

22. The method as claimed in claim 15 wherein with a threshold of a background noise suppression of the first hearing device takes place as a function of the audiometric data about the second ear or of the hardware information about the second hearing device.

23. The method as claimed in claim 15 wherein hardware information concerned with the device type, the device type selected from the group consisting of ITE, BTE, implantable hearing aid and vibrotactile hearing aid.

24. The method as claimed in claim 15 wherein the hardware information is concerned with the amplifier type.

25. The method as claimed in claim 15 wherein the hardware information is concerned with the sound transmission within the second hearing device.

26. The method as claimed in claim 15 wherein the hardware information is concerned with an acoustic characteristic of an otoplastic of the second hearing device.
